(19) United States
(12) Patent Application Publication
(10) Pub. No.: US 2007/0178289 A1
(43) Pub. Date: Aug. 2, 2007

(54) High-speed routing composite material

(75) Inventors: Moises Cases, Austin, TX (US); Daniel N. de Araujo, Cedar Park, TX (US); Bradley D. Herrman, Cary, NC (US); Erdem Matoglu, Austin, TX (US); Pravin Patel, Cary, NC (US); Nam H. Pham, Round Rock, TX (US); Joffre A. Ratcliffe, State College, PA (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: International Business Machines Corporation, Armonk, NY (US)

(21) Appl. No.: 11/340,907

(22) Filed: Jan. 27, 2006

(51) Int. Cl. B32B 3/00

(52) U.S. Cl. 428/209; 428/901; 174/250

(57) ABSTRACT

An electronic system includes a circuit board formed from a composite material. The composite material includes fibers embedded within a substrate and the fibers are oriented substantially orthogonal to one another. A plurality of traces are formed on the board, and the plurality of traces are oriented relative to at least one of the fibers at an angle between about 17.5° and about 27.5° or between about 20.0° and about 25.0°. A pair of the traces are oriented substantially orthogonal to one another, and a pair of the traces are oriented relative to one another at an angle of about 45.0°. The fibers are fiberglass, and the substrate is an epoxy resin. The fibers have a different dielectric constant than the substrate.

### BACKGROUND OF THE INVENTION

1. Field of the Invention

The disclosure relates generally to trace designs on a circuit board and, more specifically, to a trace design relative to the orientation of fibers of a composite material used to form the circuit board.

2. Description of the Related Art

FIG. 1 illustrates a section of a conventional circuit board 10. The circuit board 10 is formed of a composite material 11 upon which electrically conductive traces 18, 20, 22 are formed. The composite material 11 is a weave of orthogonally oriented fibers 12, 14 embedded in a substrate 16. Typically, the fibers 12, 14 are a fiberglass material and the substrate 16 is an epoxy resin.

In a conventional circuit board 10, certain of the traces 18 are oriented parallel to the first fibers 14 and, thus, are oriented perpendicular to the second fibers 12. Also, certain other of the traces 20 are oriented parallel to the second fibers 12 and, thus, are oriented perpendicular to the first fibers 14. In yet other configuration, certain of the traces 22 are oriented at 45° relative to both the first and second fibers 14, 12.

An issue associated with conventional circuit boards 10 is illustrated with regard to FIGS. 2A, 2B. The circuit board 10 includes a pair of parallel data traces D+, D−. In this particular example, the D+ trace is formed directly over one of the fibers 12a, and the D− trace is formed between two of the fibers 12a, 12b. This misalignment of the traces D+, D− relative to the fibers 12a, 12b causes the traces D+, D− to be exposed to non-uniform dielectric constants. For example, the constituents of the composite material 11, which is the epoxy resin substrate 16 and the fiberglass 12, have differing dielectric constants. Tests have shown that the electric permittivity ε at trace D+, which is a function of the dielectric constants of the materials adjacent trace D+, is about 3.5, whereas the electric permittivity ε at trace D−, which is between the fibers 12a, 12b, is about 3.3.

As a result of the differing dielectric constants experienced by each of the traces D+, D−, signals passing through the traces D+, D− experience delay skew. As this term is commonly defined, delay skew occurs when multiple signals are simultaneous sent down separate legs of a pair of conductors at the same time but arrive at the end of the conductors at different times. Excessive skew in a pair of traces D+, D− may cause electromagnetic interference, crosstalk, and loss of signal. This problem is exacerbated as the length of the traces D+, D− increases. For example, if misalignment between the traces D+, D− and the fibers 12 creates a 15 picoseconds (ps) skew per inch, the data throughput within the traces D+, D− may be limited to 10 Gigabits per second (Gbps) for a trace about 7 inches long and to 5 Gbps for a trace about 15 inches long.

On proposed solution to this issue of differing dielectric constants is to run the traces 22 at 45° relative to both the first and second fibers 14. However, routing at this particular angle requires traces 22 having a greater length, and thus, requires additional space on the circuit board 10. There is, therefore, a need for a trace design and circuit board that reduces skew within the traces without requiring additional space on the circuit board.

### BRIEF SUMMARY OF THE INVENTION

Embodiments of the invention address deficiencies of the art in respect to traces on a circuit board in an electronic system and provide a novel and non-obvious configuration for reducing skew within the traces on the circuit board. The computer system includes a circuit board formed from a composite material. The composite material includes fibers embedded within a substrate and the fibers are oriented substantially orthogonal to one another. A plurality of traces are formed on the board, and the plurality of traces are oriented relative to at least one of the fibers at an angle between about 17.5° and about 27.5° or between about 20.0° and about 25.0°. A pair of the traces are oriented substantially orthogonal to one another, and a pair of the traces are oriented relative to one another at an angle of about 45.0°. The fibers are fiberglass, and the substrate is an epoxy resin. The fibers have a different dielectric constant than the substrate. Other physical orientation schemes may be suitable depending upon the requirements of the particular application.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a top view of conventional traces on a circuit board.;

FIG. 2A is another top view of a conventional pair of traces on a circuit board;

FIG. 2B is a side view of FIG. 2A; and

FIG. 3 is a top view of traces on a circuit board in accordance with the inventive arrangements.

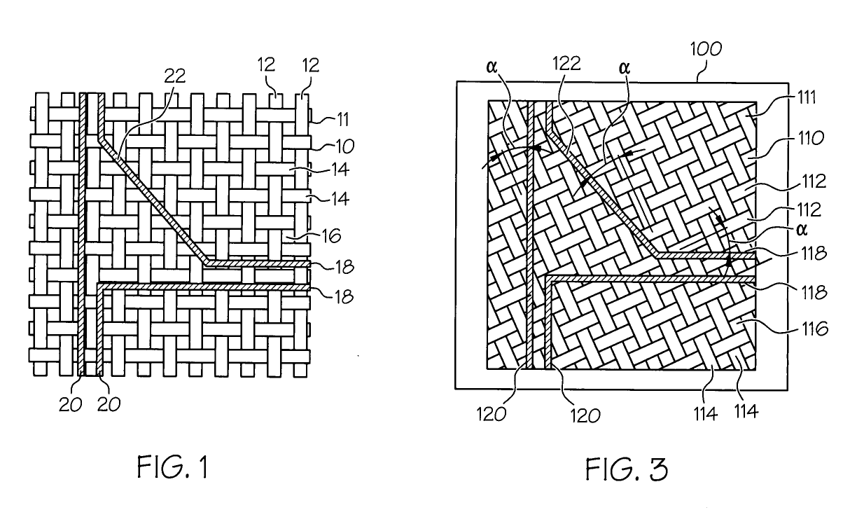

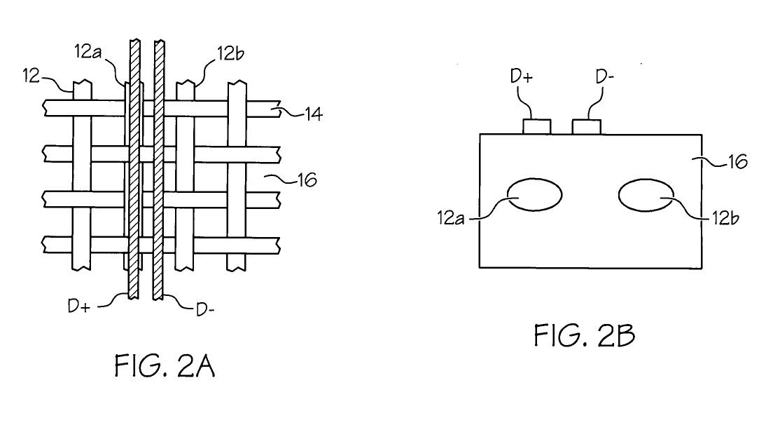

### DETAILED DESCRIPTION OF THE INVENTION

FIG. 3 illustrates a circuit board 110 within an electronic system, such as a computer system 100. The circuit board 110 is formed from a composite material 111. The composite material 111 includes fibers 112, 114 embedded within a substrate 116 and the fibers 112, 114 may be oriented substantially orthogonal to one another. Although not limited in this manner, the fibers 112, 114 may be formed from fiberglass (or other composite-suitable material) and the substrate 116 may be formed from an epoxy resin or any other suitable composite/nano-composite material. In so doing, the fibers 112, 114 have a different dielectric constant than the dielectric constant of the substrate 116.

A plurality of traces 118, 120, 122 are formed on the circuit board 110, and the plurality of traces 118, 120, 122 are oriented relative to at least one of the fibers 112, 114 at an angle α of about 22.5°. By orienting the plurality of traces 118, 120, 122 at an angle α of about 22.5° relative to at least one of the fibers 112, 114, the skew effects resulting from the traces being exposed to different materials (i.e., the fibers 112, 114 and the substrate 116) having different dielectric constants may be averaged out, thereby reducing the length limitations on the traces 118, 120, 122 resulting from the skew effects. Furthermore, this relative orientation would not require as great an amount of additional space on the circuit board 110 if the traces 118, 120, 122 were routed at an angle of 45.0°.

Although, in certain aspects of the circuit board 110, the angle α is about 22.5°, the circuit board is not limited in this manner. For example, the angle α may range between about 17.5° and about 27.5° in certain aspects or between about 20.0° and about 25.0° in other aspects. For a non-linear trace, the angle α of the non-linear trace relative to a fiber 112, 114 may be based upon a line defined using a linear regression of at least three or more relatively evenly-spaced points on the non-linear trace or any other conventionally-recognized method used to define a straight line based upon a set of non-linear points.

Although FIG. 3 illustrates the traces 118, 120 as being oriented parallel (and/or orthogonally) to edges of the circuit board 110, the circuit board 110 is not limited in this manner. For example, the fibers 112, 114 may be oriented parallel (and/or orthogonally) to the edges of the circuit board 110. In so doing, the traces 118, 120 would be oriented relative to the edges of the circuit board 110 at an angle α of about 22.5°. Alternatively, neither the fibers 112, 114 nor the traces 118, 120 may be oriented parallel (and/or orthogonally) to the edges of the circuit board 110.

In certain aspects of the circuit board 110, a pair of connecting traces 120, 118 are oriented substantially orthogonal to one another. The circuit board 110 may also includes a pair of connecting traces 118, 122 that are oriented relative to one another at an angle of about 45.0°. The circuit board 110, however, is not limited in this manner as connecting pairs of traces may having other angles relative to one another.

What is claimed is:

1. A circuit board, comprising:
a board formed from a composite material of fibers embedded within a substrate and the fibers oriented substantially orthogonal to one another;
a plurality of traces formed on the board, wherein
the plurality of traces are oriented relative to at least one of the fibers at an angle between about 17.5° and about 27.5°.

2. The circuit board of claim 1, wherein the angle is between about 20.0° and about 25.0°.

3. The circuit board of claim 1, wherein a pair of the traces are oriented substantially orthogonal to one another.

4. The circuit board of claim 1, wherein a pair of the traces are oriented relative to one another at an angle of about 45.0°.

5. The circuit board of claim 1, wherein the fibers are fiberglass.

6. The circuit board of claim 5, wherein the substrate is an epoxy resin.

7. The circuit board of claim 1, wherein the fibers having a different dielectric constant than the substrate.

8. An electronic system, comprising:
a circuit board formed from a composite material, the composite material including fibers embedded within a substrate and the fibers oriented substantially orthogonal to one another;
a plurality of traces formed on the board, wherein
the plurality of traces are oriented relative to at least one of the fibers at an angle between about 17.5° and about 27.5°.

9. The electronic system of claim 8, wherein the angle is between about 20.0° and about 25.0°.

10. The electronic system of claim 8, wherein a pair of the traces are oriented substantially orthogonal to one another.

11. The electronic system of claim 8, wherein a pair of the traces are oriented relative to one another at an angle of about 45.0°.

12. The electronic system of claim 8, wherein the fibers are fiberglass.

13. The electronic system of claim 12, wherein the substrate is an epoxy resin.

14. The electronic system of claim 8, wherein the fibers having a different dielectric constant than the substrate.
